(19) United States
(12) Patent Application Publication
(10) Pub. No.: US 2007/0168653 A1
(43) Pub. Date: Jul. 19, 2007

(54) Computer hardware operating mode setting circuit

(75) Inventors: Tracy Han, Taipei (TW); Christina Yang, Taipei (TW)

Correspondence Address: EDWARDS ANGELL PALMER & DODGE LLP, P.O. BOX 55874, BOSTON, MA, 02205, US

(73) Assignee: Inventec Corporation, Taipei (TW)

(21) Appl. No.: 11/336,128

(22) Filed: Jan. 19, 2006

(51) Int. Cl. G06F 1/24

(52) U.S. Cl. 713/100

(57) ABSTRACT

A computer hardware operating mode setting circuit is proposed, which is designed for use with a hardware module, such as a BIOS module, to provide the BIOS module with a user-manipulated operating mode setting function; and which is characterized by the capability of using just 3 connecting pads, rather than 4 in the case of the prior art, for the user-selected connection of either a pull-up resistor or a pull-down resistor to the BIOS module for the purpose of setting the BIOS module to either an enabled state or a disabled state for a particular operating mode, such as BIOS write mode. This feature allows the circuit board where the BIOS module is mounted to be implemented with a smaller layout area and thus made more compact in size than the prior art.

### BACKGROUND OF THE INVENTION

1. Field of the Invention

This invention relates to computer logic circuit technology, and more particularly, to a computer hardware operating mode setting circuit which is designed for use in conjunction with a hardware module, such as a BIOS (Basic Input/Output System) module on a computer motherboard, and which allows the user to selectively connect the BIOS module to either a pull-up resistor or a pull-down resistor for the purpose of setting the BIOS module to a desired operating mode, such as to enable or disable a data write function of the BIOS module.

2. Description of Related Art

In the manufacture of computer motherboards, it is a required step to write a set of BIOS (Basic Input/Output System) code into a non-volatile memory module, such as a flash memory module. In actual implementation, a BIOS module (i.e., flash memory module) is typically provided with a special pin called BIOS write enable/disable port. When it is desired to write data into the BIOS module, the hardware engineer is required to connect the BIOS write enable/disable port to a pull-up resistor for the purpose of setting the BIOS write enable/disable port at a logic-HIGH voltage state to thereby enable the BIOS write function of the BIOS module. On the other hand, when the data write procedure is completed, the hardware engineer needs to remove the pull-up resistor and instead connect the BIOS write enable/disable port to a pull-down resistor for the purpose of setting the BIOS write enable/disable port to a logic-LOW voltage state to thereby disable the BIOS write function.

FIG. 1 shows the circuit layout of a conventional computer hardware operating mode setting circuit 100. As shown, this conventional computer hardware operating mode setting circuit 100 is designed for use in conjunction with a BIOS module 10 that is provided with a BIOS write enable/disable port (BIOS_WE) 11, and which is composed of a circuit substrate 110 and 4 connecting pads including a first pad 121, a second pad 122, a third pad 123, and a fourth pad 124; wherein the first pad 121 is electrically connected to a system voltage (+V3S); the second pad 122 and the third pad 123 are both connected to the BIOS write enable/disable port (BIOS_WE) 11 of the BIOS module 10; and the fourth pad 124 is electrically connected to a ground point (GND).

When the hardware engineer wants to write a set of data, such as a new version of BIOS code, to the BIOS module 10, the hardware engineer needs first to connect a first resistor 130 across the first pad 121 and the second pad 122 while leaving the third pad 123 and the fourth pad 124 unconnected. This type of connection allows the first resistor 130 to serve as a pull-up resistor which electrically connects the system voltage (+V3S) to the BIOS write enable/disable port (BIOS_WE) 11, thereby setting the BIOS write enable/disable port (BIOS_WE) 11 at a logic-HIGH voltage state that enables the BIOS write function of the BIOS module 10. Under this condition, the hardware engineer can perform a data write procedure on the BIOS module 10.

After the data write procedure is completed, the hardware engineer can then remove the first resistor 130 from the circuit substrate 110 and then connects the second resistor 140 across the third pad 123 and the fourth pad 124. This type of connection allows the second resistor 140 to server as a pull-down resistor which electrically connects the BIOS write enable/disable port (BIOS_WE) 11 of the BIOS module 10 to the ground point (GND), thereby setting the BIOS write enable/disable port (BIOS_WE) 11 at a logic-LOW voltage state that disables the BIOS write function of the BIOS module 10. Under this condition, the BIOS module 10 is protected against the writing of data therein.

One drawback to the above-mentioned prior art of FIG. 1, however, is that its implementation requires the provision of at least 4 connecting pads, and therefore would occupy a larger layout area on the computer motherboard, which makes the computer motherboard less compact in size.

### SUMMARY OF THE INVENTION

It is therefore a primary objective of this invention to provide a computer hardware operating mode setting circuit which can be implemented with a smaller number of connecting pads and thus a smaller layout area on the motherboard so as to allow the computer motherboard to be made more compact in size than the prior art.

The computer hardware operating mode setting circuit according to the invention is designed for use in conjunction with a hardware module, such as a BIOS (Basic Input/Output System) module on a computer motherboard, and which allows the user to selectively connect the BIOS module to either a pull-up resistor or a pull-down resistor for the purpose of setting the BIOS module to a desired operating mode, such as to enable or disable a data write function of the BIOS module.

Structurally, the computer hardware operating mode setting circuit according to the invention comprises: (a) a circuit substrate; (b) a first pad, which is provided on the circuit substrate, and which is electrically connected to the operating mode setting port of the hardware module; (c) a second pad, which is provided on the circuit substrate, and which is electrically connected to a system voltage; (d) a third pad, which is provided on the circuit substrate, and which is electrically connected to a grounding point; (e) a first resistor, which is selectively connected between the first pad and the second pad for electrically connecting the system voltage to the operating mode setting port of the hardware module for the purpose of setting the operating mode setting port at a logic-HIGH voltage state; and (f) a second resistor, which is selectively connected between the first pad and the third pad for connecting the operating mode setting port of the hardware module to the grounding point for the purpose of setting the operating mode setting port at a logic-LOW voltage state.

The computer hardware operating mode setting circuit according to the invention is characterized by the capability of using just 3 connecting pads, rather than 4 in the case of the prior art, for the user-selected connection of either a pull-up resistor or a pull-down resistor to the BIOS module for the purpose of setting the BIOS module to either an enabled state or a disabled state for a particular operating mode, such as BIOS write mode. This feature allows the circuit board where the BIOS module is mounted to be implemented with a smaller layout area and thus made more compact in size than the prior art.

### BRIEF DESCRIPTION OF DRAWINGS

The invention can be more fully understood by reading the following detailed description of the preferred embodiments, with reference made to the accompanying drawings, wherein:

FIG. 1 (PRIOR ART) is a schematic diagram showing a conventional 4-pad computer hardware operating mode setting circuit for a BIOS module;

FIG. 2 is a schematic diagram showing the application of the computer hardware operating mode setting circuit of the invention with a BIOS module;

FIG. 3A is a schematic diagram showing a first preferred embodiment of the computer hardware operating mode setting circuit of the invention;

FIG. 3B is a schematic diagram showing a second preferred embodiment of the computer hardware operating mode setting circuit of the invention;

FIG. 4A is a schematic diagram showing the utilization of the computer hardware operating mode setting circuit of the invention to set a logic-HIGH voltage state to a BIOS module; and

FIG. 4B is a schematic diagram showing the utilization of the computer hardware operating mode setting circuit of the invention to set a logic-LOW voltage state to a BIOS module.

### DETAILED DESCRIPTION OF PREFERRED EMBODIMENTS

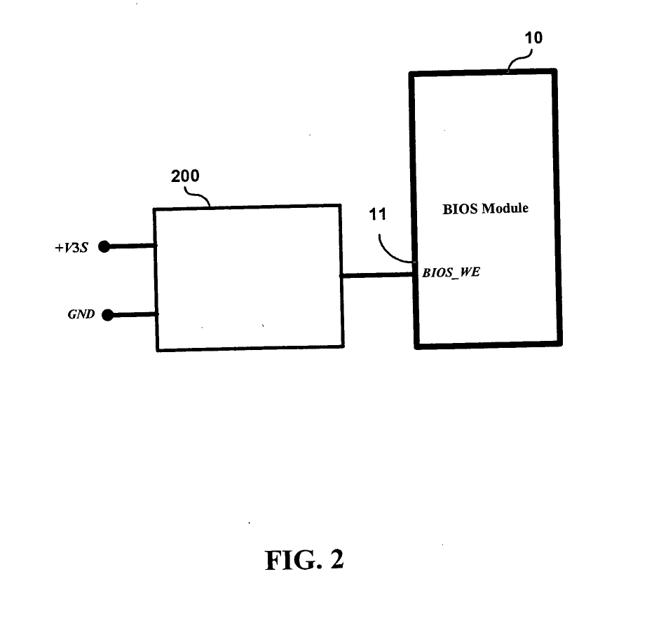

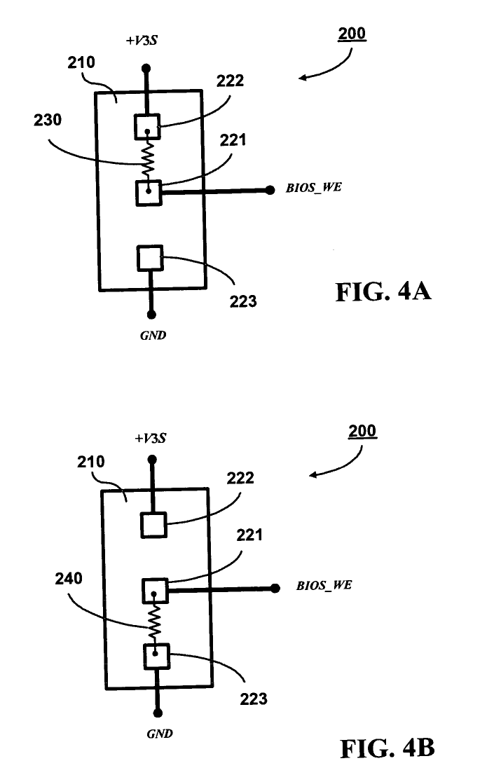

The computer hardware operating mode setting circuit according to the invention is disclosed in full details by way of preferred embodiments in the following with reference to FIG. 2 to FIGS. 4A-4B.

FIG. 2 is a schematic diagram showing the application of the computer hardware operating mode setting circuit according to the invention (as the block indicated by the reference numeral 200). As shown, the computer hardware operating mode setting circuit of the invention 200 is designed for use in conjunction with a computer hardware module, such as a BIOS (Basic Input/Output System) module 10 on a computer motherboard, that is provided with an operating mode setting port, such as a BIOS write enable/disable port (BIOS_WE) 11, for the purpose of allowing the user to set the BIOS module 10 to either a BIOS write enabled state or a disabled state.

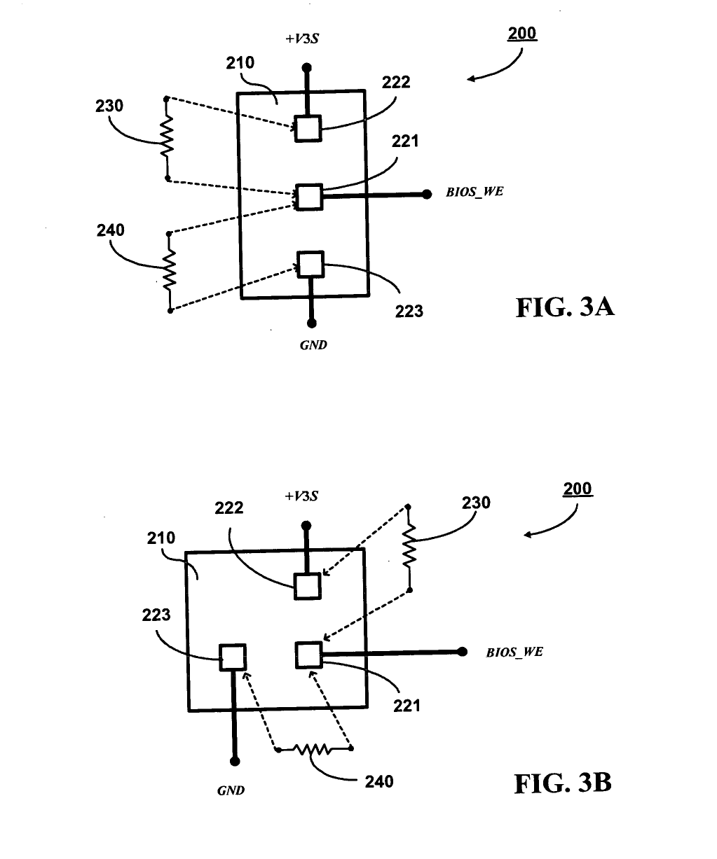

FIG. 3A and FIG. 3B show two preferred embodiments of the computer hardware operating mode setting circuit of the invention 200. Structurally, the computer hardware operating mode setting circuit of the invention 200 comprises: (a) a circuit substrate 210; (b) a first pad 221; (c) a second pad 222; (d) a third pad 223; (e) a first resistor 230; and (f) a second resistor 240. In the first preferred embodiment shown in FIG. 3A, for example, the first pad 221, the second pad 222, and the third pad 223 are arranged in a lined array on the circuit substrate 210; while in the second preferred embodiment shown in FIG. 3B, the first pad 221, the second pad 222, and the third pad 223 are arranged in a substantially L-shaped array on the circuit substrate 210.

The circuit substrate 210 can be either a separate circuit board or an integral part of the computer motherboard (not shown) where the BIOS module 10 is mounted, and which is used to mount the first pad 221, the second pad 222, and the third pad 223, wherein the first pad 221 is electrically connected to the BIOS write enable/disable port (BIOS_WE) 11 of the BIOS module 10; the second pad 222 is electrically connected to a system voltage (+V3S); and the third pad 223 is electrically connected to a ground point (GND).

The first resistor 230 can be selectively connected by the user between the first pad 221 and the second pad 222 to serve as a pull-up resistor for electrically connecting the system voltage (+V3S) to the BIOS write enable/disable port (BIOS_WE) 11 of the BIOS module 10 for the purpose of setting the BIOS write enable/disable port (BIOS_WE) 11 at a logic-HIGH voltage state. It is to be noted that when the first resistor 230 is user-selected or connection on the circuit substrate 210, the second resistor 240 is unused.

The second resistor 240 can be selectively connected by the user between the first pad 221 and the third pad 223 for connecting the BIOS write enable/disable port (BIOS_WE) 11 of the BIOS module 10 to the ground point (GND) for the purpose of setting the BIOS write enable/disable port (BIOS_WE) 11 at a logic-LOW voltage state. It is to be noted that when the second resistor 240 is user-selected for connection on the circuit substrate 210, the first resistor 230 is unused.

The following is a detailed description of a practical application example of computer hardware operating mode setting circuit of the invention 200 in actual utilization.

In the utilization of the BIOS module 10, when the user (i.e., hardware engineer) wants to write a set of data, such as a new version of BIOS code, to the BIOS module 10, the user can then connect the first resistor 230 across the first pad 221 and the second pad 222 in a manner as shown in FIG. 3A while leaving the second resistor 240 unconnected across the first pad 221 and the third pad 223. This type of connection allows the first resistor 230 to serve as a pull-up resistor which electrically connects the system voltage (+V3S) to the BIOS write enable/disable port (BIOS_WE) 11, thereby setting the BIOS write enable/disable port (BIOS_WE) 11 at a logic-HIGH voltage state that enables the BIOS write function of the BIOS module 10. Under this condition, the hardware engineer can perform a data write procedure on the BIOS module 10.

After the data write procedure is completed, the hardware engineer can then remove the first resistor 230 from the circuit substrate 210 and then connects the second resistor 240 across the first pad 221 and the third pad 223 in a manner as shown in FIG. 3B. This connection allows the second resistor 240 to server as a pull-down resistor which electrically connects the BIOS write enable/disable port (BIOS_WE) 11 of the BIOS module 10 to the ground point (GND), and thereby sets the BIOS write enable/disable port (BIOS_WE) 11 at a logic-LOW voltage state that disables the BIOS write function of the BIOS module 10. Under this condition, the BIOS module 10 is protected against the writing of data therein.

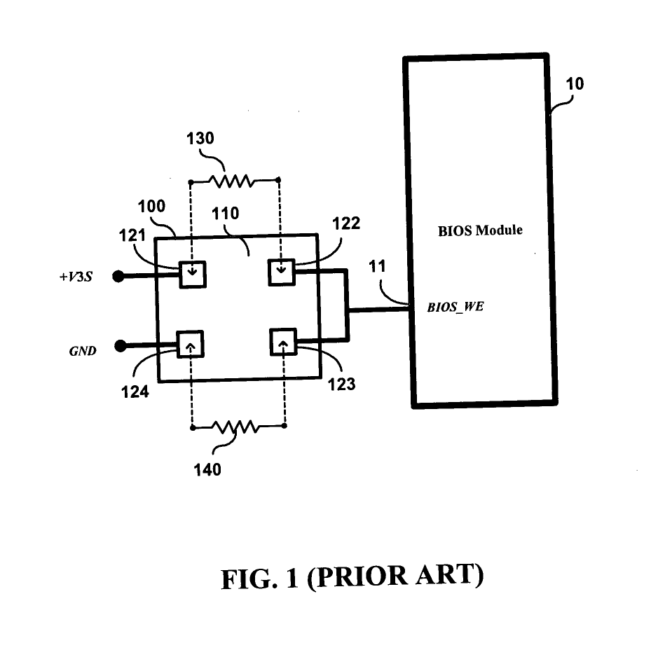

Compared to the prior art, the computer hardware operating mode setting circuit of the invention 200 needs just 3 connecting pads (i.e., the first pad 221, the second pad 222, and the third pad 223), rather than 4 connecting pads (i.e., the pads 121, 122, 123, 124) in the case of the prior art of FIG. 1 to offer the user with an operating mode setting function. Consequently, the computer hardware operating mode setting circuit of the invention 200 can be implemented by using a smaller circuit layout area on the circuit substrate 210, allowing the computer motherboard (not shown) where the BIOS module 10 is mounted to be made more compact in size than the prior art.

In conclusion, the invention provides a computer hardware operating mode setting circuit for use with a hardware module, such as a BIOS module, to provide the BIOS module with a user-manipulated operating mode setting function; and which is characterized by the capability of using just 3 connecting pads, rather than 4 in the case of the prior art, for the user-selected connection of either a pull-up resistor or a pull-down resistor to the BIOS module for the purpose of setting the BIOS module to either an enabled state or a disabled state for a particular operating mode, such as BIOS write mode. This feature allows the circuit board where the BIOS module is mounted to be implemented with a smaller layout area and thus made more compact in size than the prior art. The invention is therefore more advantageous to use than the prior art.

The invention has been described using exemplary preferred embodiments. However, it is to be understood that the scope of the invention is not limited to the disclosed embodiments. On the contrary, it is intended to cover various modifications and similar arrangements. The scope of the claims, therefore, should be accorded the broadest interpretation so as to encompass all such modifications and similar arrangements.

What is claimed is:

1. A computer hardware operating mode setting circuit for use with a hardware module that is provided with an operating mode setting port, which comprises;
a circuit substrate;
a first pad, which is provided on the circuit substrate, and which is electrically connected to the operating mode setting port of the hardware module;
a second pad, which is provided on the circuit substrate, and which is electrically connected to a system voltage;
a third pad, which is provided on the circuit substrate, and which is electrically connected to a grounding point;
a first resistor, which is selectively connected between the first pad and the second pad for electrically connecting the system voltage to the operating mode setting port of the hardware module for the purpose of setting the operating mode setting port at a logic-HIGH voltage state; and
a second resistor, which is selectively connected between the first pad and the third pad for connecting the operating mode setting port of the hardware module to the grounding point for the purpose of setting the operating mode setting port at a logic-LOW voltage state.

2. The computer hardware operating mode setting circuit of claim 1, wherein the hardware module is a BIOS (Basic Input/Output System) module.

3. The computer hardware operating mode setting circuit of claim 1, wherein the operating mode setting port is a BIOS (Basic Input/Output System) write enable/disable port.

4. The computer hardware operating mode setting circuit of claim 1, wherein the first pad, the second pad, and the third pad are arranged in a lined array on the circuit substrate.

5. The computer hardware operating mode setting circuit of claim 1, wherein the first pad, the second pad, and the third pad are arranged in a substantially L-shaped array on the circuit substrate.
